(19) United States
(12) Patent Application Publication
(10) Pub. No.: US 2026/0296305 A1
(43) Pub. Date: Oct. 1, 2026

(54) Lighting Device for a Motor Vehicle

(71) Applicant: Bayerische Motoren Werke Aktiengesellschaft, Muenchen (DE)

(72) Inventors: Jana HAFTENDORN, Muenchen (DE); Emilie HOBRUECKER, Muenchen (DE); Alexandra KORNDOERFER, Muenchen (DE); Alexander KUBITZ, Muenchen (DE); Michael MUELLER, Muenchen (DE)

(21) Appl. No.: 19/478,397

(22) PCT Filed: Sep. 25, 2024
(86) PCT No.: PCT/EP2024/076822

§ 371 Date: Oct. 24, 2025

(30) Foreign Application Priority Data
Oct. 16, 2023 (DE) 10 2023 128 233.6

(51) Int. Cl. B60Q 3/66; B60Q 3/10; B60Q 3/217; F21V 7/00; F21W 106/00; F21Y 113/17; F21Y 115/10

(52) U.S. Cl. CPC B60Q 3/66; B60Q 3/10; B60Q 3/217; F21V 7/00; B60Q 1/28; B60Q 1/30; B60Q 1/32; F21W 2106/00; F21Y 2113/17; F21Y 2115/10

(57) ABSTRACT

A lighting device for a motor vehicle includes a plurality of light sources and a cover plate. The plurality of light sources emit light via the cover plate during operation. A plurality of reflectors are provided in the lighting device and each light source of the plurality of light sources is separately associated with a reflector of the plurality of reflectors. The reflector surrounds the associated light source and widens starting from the associated light source towards the cover plate. Mutually adjacent reflectors are connected to each other via webs, which are at a distance from the cover plate.

### BACKGROUND AND SUMMARY

The invention relates to a lighting device for a motor vehicle and a corresponding motor vehicle.

Motor vehicle lighting devices are known from the prior art, which generate a light distribution in the interior or exterior of the corresponding motor vehicle based on a matrix made up of a plurality of light sources.

Document DE 10 2008 013 603 A1 discloses a light module for a lighting device of a motor vehicle having multiple semiconductor light sources arranged in a matrix. The individual semiconductor light sources emit into respective optical elements that can be designed as reflectors, for example. The light of the light sources is projected via a projection lens arrangement to achieve a desired light distribution on a roadway in front of the motor vehicle.

An interior light for a motor vehicle is disclosed in document US 2019/0299851 A1, which comprises light sources arranged in a matrix that emit light into individual optical fibers.

The light distribution generated using a lighting device made up of a matrix structure of light sources is easy to resolve for the viewer and has a very technical effect, in particular in the case of dynamic light effects. It is often desirable, however, to achieve a natural or organic appearance of the light distribution.

The object of the invention is to provide a lighting device for a motor vehicle which generates a light distribution having improved appearance using a plurality of light sources.

This object is achieved by the lighting device according to the claimed invention.

The lighting device according to embodiments of the invention is provided for a motor vehicle. The motor vehicle is preferably a passenger vehicle, but can possibly also be a truck or a motorcycle. Insofar that interactions between the lighting device and the motor vehicle are described hereinafter and in particular in the claims, this is always to be understood to mean that the interaction occurs upon arrangement or installation of the lighting device in the motor vehicle. The components of the lighting device which have a corresponding interaction with the motor vehicle or components of the motor vehicle are therefore designed such that the interaction is induced upon arrangement or installation of the lighting device in the motor vehicle.

The lighting device according to embodiments of the invention comprises a plurality of light sources and a cover pane, wherein the plurality of light sources emit light via the cover pane in operation. A cover pane is to be understood here as a light-transmissive pane which at least partially transmit the light incident thereon. The transmittance of the cover pane can be different. Preferably, the transmittance is 50% or more. In one preferred embodiment, the cover pane is a diffuser pane, which diffusely distributes the light incident thereon.

The lighting device furthermore contains a plurality of reflectors, wherein each light source of the plurality of light sources is assigned to a separate reflector of the plurality of reflectors. In other words, precisely one specific reflector is associated with each light source. The reflector surrounds the assigned light source and widens toward the cover pane starting from the assigned light source. Reflectors adjoining one another are connected to one another in this case via webs which are spaced apart from the cover pane.

A good distribution and mixing of the light radiation of the individual light sources is achieved using the widening reflectors. Because corresponding webs between reflectors adjoining one another are spaced apart from the cover pane, it is furthermore ensured that the light of each light source radiates out somewhat beyond the respective reflector outline. In this way, the light also becomes thoroughly mixed between the reflectors and the transitions between the reflectors are not recognizable via the cover pane. A naturally appearing light distribution can thus be generated.

In one preferred embodiment, the lighting device according to the invention is intended for the interior of a motor vehicle, i.e. it is an interior light. The lighting device can be installed in this case at arbitrary points in the interior. The lighting device is preferably intended for installation in the dashboard (instrument panel) of the motor vehicle or in a vehicle door of the motor vehicle. In an alternative variant, the lighting device according to the invention is an exterior light, which is intended for lighting the exterior of the motor vehicle.

In one particularly preferred embodiment, a respective light source of the plurality of light sources is an RGB-LED unit, i.e. a unit containing a red, a green, and a yellow LED, the colors of which are mixed. The widening shape of the respective reflectors is particularly advantageous for this embodiment, since in this way very good mixing of the colors of the three LEDs is effectuated.

In a further preferred variant, the light sources of the plurality of light sources are arranged on a common circuit board, by which a complex structure of the lighting device is ensured.

In a further preferred embodiment, a respective reflector of the plurality of reflectors is light-scattering, i.e. the light is diffusely distributed via the reflector and not directly reflected. For this purpose, the respective reflector preferably has a white surface, which can be matte, for example.

In one preferred embodiment of the lighting device according to the invention, a respective reflector of the plurality of reflectors comprises multiple polygonal surfaces. For example, at least a part of the multiple polygonal surfaces can each be formed triangular. Preferably, at least a part of the multiple polygonal surfaces each have an edge, which is associated with a web, arranged at a distance from the assigned light source. A simple structure of the individual reflectors is ensured by the embodiment just described.

In a further preferred variant of the lighting device according to the invention, at least a part of the plurality of reflectors each have a border, which extends around the assigned light source in a top view and is formed from webs, arranged at a distance from the assigned light source. The border preferably has the shape of a hexagon. The lighting device therefore contains one or more reflectors which emit light circumferentially into other reflectors and therefore ensure very good mixing and distribution of the light of the light sources.

In a further, particularly preferred embodiment, the plurality of reflectors is integrally formed in a one-piece component, wherein the one-piece component is preferably a plastic component, in particular an injection-molded component. This embodiment ensures simple production of the reflectors.

In a further embodiment, the plurality of reflectors is surrounded by a circumferential border, on which the cover pane is fastened. A simple assembly of the reflectors with the cover pane is ensured in this way. The circumferential border which surrounds the plurality of reflectors preferably has a shape differing from a rectangle. The shape of the lighting device can therefore be adapted flexibly to the installation location in the motor vehicle.

In a further preferred variant, the cover pane is coated using a layer which is light-transmissive for the light of the plurality of light sources, wherein the transmittance of the layer is preferably between 3% and 30%, in particular between 3% and 20%.

The layer of the above embodiment is preferably designed such that in the switched-off state of the plurality of light sources, the cover pane, the plurality of light sources, and the plurality of reflectors do not shine through the layer. In this way, the lighting device is not visible in the deactivated state. This variant of the invention is preferably used if the lighting device is intended for the interior of the motor vehicle. It is often desirable therein for the lighting device not to be recognizable in the cold appearance.

The layer using which the cover pane is coated can be designed differently. For example, the layer can be formed from textile material or it can be a layer made of TPO (TPO=thermoplastic polyolefin), in particular a TPO film. If the lighting device is used in the interior of a motor vehicle, the layer can be a furnishing material of the interior.

In addition to the lighting device according to embodiments of the invention, the invention relates to a motor vehicle which comprises one or more of the lighting devices according to embodiments of the invention.

Exemplary embodiments of the invention are described in more detail hereinafter on the basis of the appended figures.

### BRIEF DESCRIPTION OF THE DRAWINGS

FIG. 1 shows a perspective view of an embodiment of a lighting device according to the invention.

FIG. 2 shows a sectional view along line L-L of FIG. 1.

### DETAILED DESCRIPTION OF THE DRAWINGS

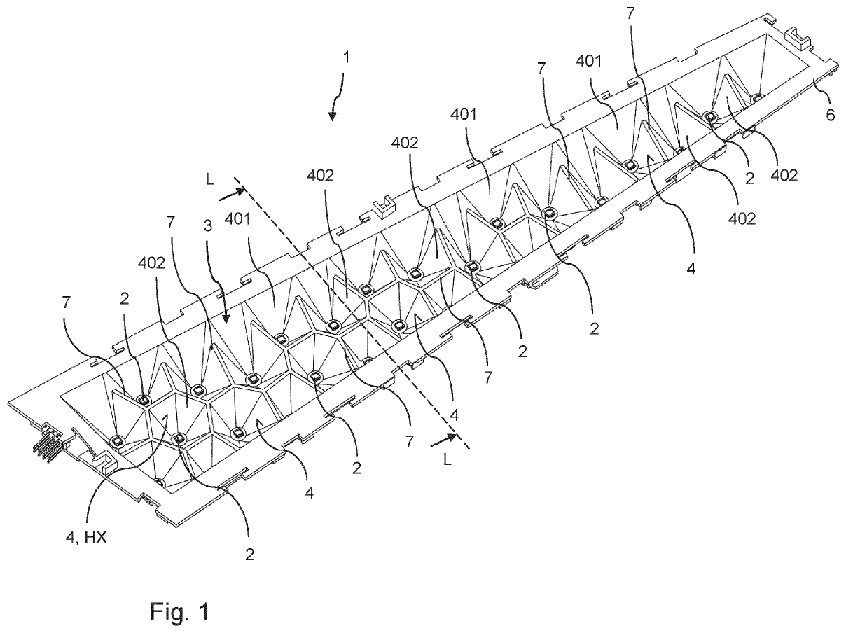

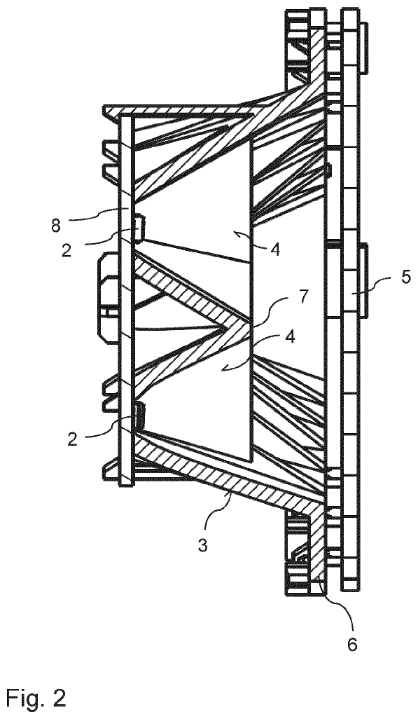

In FIG. 1 and FIG. 2, only components essential for embodiments of the invention are identified by corresponding reference signs. Only these components are explained in more detail hereinafter.

FIG. 1 shows a perspective view of an embodiment of a lighting device 1 according to the invention. In this case, this is an interior light which is fastened in the dashboard of a motor vehicle via suitable fasteners, wherein the dashboard and the fasteners are not visible in FIG. 1. The lighting device comprises a reflector box 3, which is designed as a one-piece plastic component and has a matte white surface. The reflector box widens in the illustration of FIG. 1 in the direction from right to left and comprises a peripheral circumferential border 6. A cover pane 5 is fastened on the circumferential border 6, which is not visible in FIG. 1 but is shown in the sectional view of FIG. 2. In the embodiment described here, the cover pane is a diffuser pane. Alternatively, the cover pane can also be designed as a transmissive non-scattering pane.

A plurality of reflectors 4 is formed inside the circumferential border 6. A light source 2 in the form of an RGB-LED unit, which contains a red, a green, and a yellow LED, the colors of which mix to form a suitable mixed color, is located at the bottom of each reflector. For reasons of clarity, the light sources and the reflectors are only partially identified by the reference signs 2 and 4, respectively. All RGB-LED units are arranged on a common circuit board 8, via which they are operable and are jointly supplied with power. The circuit board 8 is not visible in FIG. 1 but is shown in FIG. 2, which is explained below.

The individual reflectors 4 each comprise polygonal reflector surfaces, which enclose the respective light sources 2. In this case there are reflector surfaces 401 which extend up to the circumferential border 6 and reflector surfaces 402 which end at a web 7. For reasons of clarity, only a few of the reflector surfaces provided are identified by the corresponding reference signs 401 and 402 in FIG. 1. Likewise, only a part of the webs are identified by the reference sign 7.

The individual reflectors 4 are shaped differently, but each reflector contains at least one web 7 which is also associated with an adjoining reflector. In the embodiment of FIG. 1, there is a reflector 4 which comprises a circumferential edge that consists exclusively of webs and has the shape of a hexagon. This reflector is identified by the additional reference sign HX. The size of the reflectors is designed in the embodiment of FIG. 1 such that the individual reflectors achieve the same brightness as much as possible at equal power of the respective light sources 2.

A feature of the embodiment of FIG. 1 essential to the invention is that the individual reflectors 4 widen in the direction toward the cover pane 5 starting from the respective light sources 2. In this way, good light mixing of the LEDs of the respective RGB-LED units can be effectuated. A further aspect of the embodiment of FIG. 1 essential to the invention is that the webs 7 are spaced apart from the cover pane 5. This is apparent from the sectional view of FIG. 2.

Two adjacent reflectors 4 having their light sources 2 and a corresponding web 7 between the adjacent reflectors can be seen in FIG. 2. The light sources are located on a circuit board 8, on which all light sources 2 of the lighting device 1 are arranged. Furthermore, the cover pane 5 is shown in FIG. 2, which was omitted in the illustration of FIG. 1. This cover pane is fastened via suitable fasteners on the circumferential border 6 of the reflector box 3. It is apparent from FIG. 2 that the web 7 is spaced apart from the cover pane 5. As a consequence, the light of each light source or RGB-LED unit radiates somewhat beyond the reflector outline. As a result, the precise edges of the reflectors are not visible at the surface of the cover pane and the transitions between the reflectors and at the edge of the reflector box become more diffuse.

In one preferred embodiment, the cover pane 5 is coated using an elastic layer which corresponds to the material of the component of the interior in which the reflector box is installed. The layer is preferably a TPO film or a textile material. The layer contains an intrinsic sufficient pigmentation to not appear transparent when light sources 2 are switched off, but to ensure a sufficient light transmission for the through-illumination of the light effects when light sources are switched on. A transmittance of the layer is expediently between 3% and 20%.

The embodiments of the invention described above have an array of advantages. In particular, a lighting device for a motor vehicle is provided which generates natural light via a plurality of light sources arranged in corresponding reflectors. The shaping of the reflectors enables good thorough mixing of the light here, wherein furthermore webs spaced apart from the cover pane ensure that the light of the individual reflectors also mixes with one another.

### LIST OF REFERENCE SIGNS

1 lighting device
2 light sources (RGB-LED units)
3 reflector box
4 reflectors
401, 402 polygonal reflector surfaces
5 cover pane
6 circumferential border of the reflector box
7 webs
8 circuit board
HX reflector having circumferential webs in the form of a hexagon

1.-16. (canceled)

17. A lighting device for a motor vehicle, the lighting device comprising:
a plurality of light sources;
a cover pane, wherein the plurality of light sources emit light via the cover pane in operation; and
a plurality of reflectors, wherein:
each light source of the plurality of light sources is separately assigned to one reflector of the plurality of reflectors,
the one reflector surrounds the assigned light source and widens toward the cover pane starting from the assigned light source, and
reflectors adjoining one another are connected to one another via webs, which are spaced apart from the cover pane.

18. The lighting device according to claim 17, wherein the lighting device is a lighting device for the interior of the motor vehicle.

19. The lighting device according to claim 18, wherein the lighting device is intended for installation in a dashboard of the motor vehicle or in a vehicle door of the motor vehicle.

20. The lighting device according to claim 17, wherein the cover pane is a diffuser pane.

21. The lighting device according to claim 17, wherein a respective light source of the plurality of light sources is an RGB-LED unit and/or the plurality of light sources are arranged on a common circuit board.

22. The lighting device according to claim 17, wherein a respective reflector of the plurality of reflectors is light-scattering and has a white surface.

23. The lighting device according to claim 17, wherein a respective reflector of the plurality of reflectors is light-scattering.

24. The lighting device according to claim 17, wherein a respective reflector of the plurality of reflectors comprises multiple polygonal surfaces.

25. The lighting device according to claim 24, wherein at least a part of the multiple polygonal surfaces is each triangular and/or each has an edge, which is associated with a web, arranged at a distance from the assigned light source.

26. The lighting device according to claim 17, wherein at least a part of the plurality of reflectors each have a border arranged at a distance from the assigned light source, which border extends around the assigned light source in a top view and is formed from webs.

27. The lighting device according to claim 26, wherein the border has a shape of a hexagon.

28. The lighting device according to claim 17, wherein the plurality of reflectors is integrally formed in a one-piece component.

29. The lighting device according to claim 28, wherein the one-piece component is a plastic component.

30. The lighting device according to claim 17, wherein the plurality of reflectors is surrounded by a circumferential border, on which the cover pane is fastened.

31. The lighting device according to claim 30, wherein the circumferential border has a shape differing from a rectangle.

32. The lighting device according to claim 17, wherein the cover pane is coated with a layer which is light-transmissive for the light of the plurality of light sources.

33. The lighting device according to claim 32, wherein a transmittance of the layer is between 3% and 30%.

34. The lighting device according to claim 32, wherein the layer is configured such that in a switched-off state of the plurality of light sources, the cover pane, the plurality of light sources, and the plurality of reflectors do not shine through the layer.

35. The lighting device according to claim 32, wherein the layer is formed from textile material or is a layer made of thermoplastic polyolefin.

36. The motor vehicle comprising the lighting device according to claim 17.
